(19) United States
(12) Patent Application Publication
(10) Pub. No.: US 2011/0057359 A1
(43) Pub. Date: Mar. 10, 2011

(54) Manufacturing method for an article of photo-curing compose resin

(76) Inventors: Hsin Yuan Chen, Minsyong Township (TW); Dung Ru Wu, Puzi City (TW); Chung Yu Chen, Bade City (TW)

(21) Appl. No.: 12/585,263

(22) Filed: Sep. 10, 2009

(51) Int. Cl. B29C 35/08

(52) U.S. Cl. 264/494

(57) ABSTRACT

A manufacturing method for an article of photo-curing compose resin includes the following steps. First step is providing a plastic article with an upper surface and a bottom surface, a photo-curing compose resin, an ink layer, and a plastic material. Second, coating the photo-curing compose resin on the upper surface of the plastic article. Third, pressing and curing the photo-curing compose resin to form a plurality of patterns. Fourth step is shaping the plastic article with the patterns. Fifth step is coating the ink layer on the bottom surface of the plastic article. At the sixth step is injecting the plastic material to attach the plastic material with the ink layer.

### BACKGROUND OF THE INVENTION

1. Field of the Invention

The present invention relates to a manufacturing method for an article of photo-curing compose resin, and in particular to a manufacturing method for an article for curing the resin and then shaping the plastic multi-layer article.

2. Description of Related Art

Traditional methods for improving the surface properties of the plastic material include the following processes. One is attaching a metal film or artificial leather on the plastics and another is printing or coating modified layer on the plastics. Speaking of the first method, the adhesive strength of attachment is a key factor for the product, wherein via this first method of attachment the metal film or artificial leather can not provide protection for the inner plastic substrate. On the other hand, the metal film or artificial leather only provides simple visual effect so that the colorful features can not be presented by products formed by this first traditional method. Alternatively, an additional printing step is required for improving the visual effects on the metal film or artificial leather. However, some problems may occur in the printing step. For example, the thickness of the printing layer is not uniform, and the orange peel effect occurs. Some printing material is collected at the corner of the substrate or is printed on another object so that much of the printing material is wasted. Moreover, there may be heavy metals in the printing material, thus the product may not meet the regulation of restriction of hazardous substances directive (RoHS).

In-Mold-Decoration/Forming (IMD) process combines the forming and the decoration; thereby colorful patterns can be manufactured on the product. The surface layer is usually a material with hardness and improved abrasion properties and there are some specific and colorful patterns on the surface layer. Therefore, the surface layer has been researched and developed so as to improve hardness, anti-wear, and decoration effects. A Dual-Cure method is a commonly applied for the IMD method. The Dual-Cure method has the steps of: coating a resin on a plastic film and pre-curing the resin (please note the resin is not fully cured). Next step is printing on the bottom of the plastic film and injecting a plastic material on the bottom of the plastic film in order to form the product. A last step is curing the resin again so that the surface layer (cured resin) can provide hardness and anti-wear properties. However, the two curing steps leads to increased time and money requirement. Furthermore, the resin that has only been pre-cured (i.e. not fully cured) has no hardness and anti-wear properties so that the inner structures are easily damaged and the manufacturing yield is thus lower. On the other hand, because that the final curing step is behind the shaping step, the client (i.e. the factory for manufacturing the casing) needs to prepare the curing equipment, such as ultra-violet (UV) curing equipment so that the cost is increased.

Furthermore, some researchers have proposed that a resin without elongation property is used so that the resin can be fully cured before the shaping step. However, the research requires non-continuous resin on the substrate and the process is complex. Moreover, the non-continuous resin can not provide the protection for the inner layers or inner structures.

Therefore, in view of this, the inventor proposes the present invention to overcome the above problems based on his expert experience and deliberate research.

### SUMMARY OF THE INVENTION

The primary object of the present invention provides a manufacturing method for an article of photo-curing compose resin. The method is applied for forming a polymer layer with elongation property on a plastic article, so that the polymer layer can be cured on the plastic article and thereby forming a plastic multi-layer article. Therein the plastic multi-layer article can then be shaped as according to the IMD process. Therefore, only one curing step is performed so that the IMD process that uses the manufacturing method is simplified and optimized. The cost is thereby further reduced. Moreover, the surface of the plastic article can express some colorful patterns, features, and specific visual effects, and the surface performs as a protection layer. Thus, the IMD process can provide surface layer with multi functions.

In order to achieve the above object, the present invention provides a manufacturing method for an article of photo-curing compose resin. The method comprises providing a plastic article with an upper surface and a bottom surface, a photo-curing compose resin, an ink layer, and a plastic material; coating the photo-curing compose resins on the upper surface of the plastic article; pressing and curing the photo-curing compose resin to form a plurality of patterns; coating the ink layer on the bottom surface of the plastic article; and injecting the plastic material to attach the plastic material with the ink layer. The patterns can be various 2D/3D patterns and structures.

The present invention demonstrates that an IMD process has only one curing step (UV-curing or thermal-curing step). Thus, it is not necessary for the client to cure the polymer resin. Furthermore, the polymer resin is fully cured and has improved hardness and anti-wear properties so that the surface layer can protect the substrate from damage in transportation or processing and thereby the manufacturing yield is improved.

In order to better understand the characteristics and technical contents of the present invention, a detailed description thereof will be made with reference to the accompanying drawings. However, it should be understood that the drawings and the description are illustrative only and are not for limiting the scope of the present invention.

### BRIEF DESCRIPTION OF THE DRAWINGS

FIG. 1 is a flow chart showing a manufacturing method for an article of photo-curing compose resin according to present invention; and

FIGS. 2A to 2D show the operation schematic diagram of the manufacturing method according to the present invention.

### DETAILED DESCRIPTION OF THE PREFERRED EMBODIMENTS

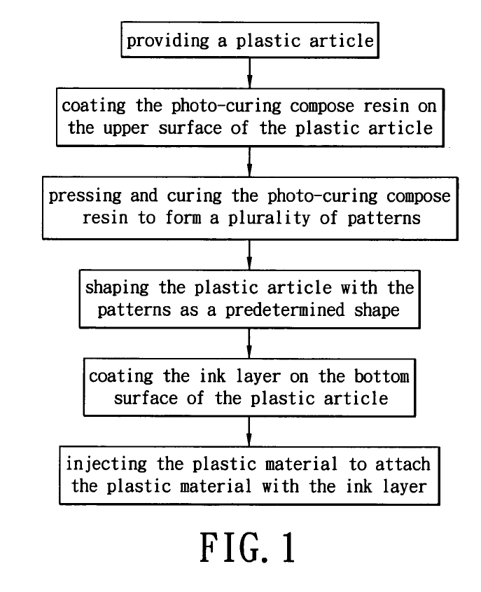

Please refer to FIG. 1; the present invention provides a method for manufacturing an article 1 of photo-curing compose resin. The method provides a photo-curing compose resin with high elongation property on the top surface of the plastic article 10 in order to form patterns 11 with elongation property on the plastic article 10 (shown in FIG. 3). Thereby the plastic article 10 and the patterns 11 can be formed together into a 1 with predetermined shape. The method has the following steps:

Step one is providing a plastic article 10. The plastic article 10 is made of, for example, Polyethylene Terephthalate (PET), Polycarbonate (PC), Tri-acetyl Cellulose (TAC), Polymethylmethacrylate (PMMA), Methylmethacrylate (styrene), Cyclic Olefin Copolymer (COC), and so on. In the present embodiment, the thickness of the plastic article 10 is from 10 μm to 1000 μm in accordance with different applications.

Step two is coating a photo-curing compose resin on the upper surface of the plastic article 10, shown in FIG. 3. In this step, the photo-curing compose resin has elongation property and is coated on upper surface of the plastic article 10 by screen printing method, roller coating method, or round-die coating method.

The photo-curing compose resin is classified into a thermal-curing resin and a UV-curing resin. In one embodiment, the UV-curing resin includes one or more than two of full acrylate resin, polyester acrylate oligomer, epoxy acrylate oligomer, and polyurethane acrylate oligomer. The UV-curing resin is about from 5% to 95% of the photo-curing compose resin. Furthermore, the UV-curing resin can be distributed uniformly in one dilution and the dilution is a monomer. The monomer includes one or more than two of monofunctional monomer, difunctional monomer, trifunctional monomer, and multifunctional monomer. For example, the monofunctional monomer can be PHEA (2-phenoxy ethyl acrylate), PH3EOA (Ethoxylated Phenoxyl Acrylate), CTFA (Cyclic Trimethylol-propane Formal Acrylate), BA (Benzyl Acrylate), LA (Lauryl Acrylate), LMA (Lauryl Methacrylate), SA (Stearyl Acrylate), SMA (Stearyl Methacrylate), ISODA (Isodecyl Acrylate), ODA (C8-C10 Acrylate), IBOA (Isobornyl Acrylate), IBOMA (Isobornyl Methacrylate), EOEOEA (2-(2-Ethoxyethoxy) Ethyl Acrylate) and the formula thereof is shown below:

### Mono(meth)acrylate (R₁═H, CH₃)

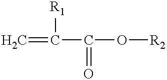

The difunctional monomer can be HPHPDA (Hydroxypivalyl Hydroxypivalate Diacrylate), DCPDA (dicyclopentadiene acrylate), HDDA (1,6-hexanediol diacrylate), HD2EODA (Ethoxylated 1,6-Hexanediol Diacrylate), DPGDA (Dipropylene Glycol Diacrylate), TPGDA (Tripropylene Glycol Diacrylate), PEGDA (Polyethylene Glycol Diacrylate), NPGDA (Neopentyl Glycol Diacrylate), NPG2PODA (Propoxylated Neopentyl Glycol Diacrylate), MPDDA (EM2280 2-Methyl-1,3-Propanediol Diacrylate), BEPDDA (2-Butyl-2-Ethyl-1,3-Propanediol Diacrylate), BPA4EODA (Ethoxylated Bisphenol-A Diacrylate), BPA10EODA (Ethoxylated Bisphenol-A Diacrylate), MPDDA (2-Methyl-1,3-Propanediol Diacrylate), MPD2EODA (Ethoxylated2 2-Methyl-1,3-Propanediol), EGDMA (Ethylene Glycol Dimethacrylate), PEGDMA (Polyethylene Glycol Dimethacrylate), BPA2EODMA (Ethoxylated Bisphenol-A Dimethacrylate), BPA4EODMA (Ethoxylated Bisphenol-A Dimethacrylate), BPA10EODMA (Ethoxylated Bisphenol-A Dimethacrylate), 3EGDMA (Triethylene Glycol Dimethacrylate), DEGDMA (Diethylene Glycol Dimethacrylate), HEMAP (2-Hydroxyethyl methacrylate phosphate) and the formula thereof is shown below:

### Di(meth)acrylate (R₁═H, CH₃)

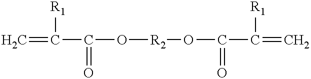

The trifunctional monomer can be THEICTA (tris(2-hydroxyethyl)-isocyanurate triacrylate), TMPTA (trimethylol propane triacrylate), PET3A (Pentaerythritol Triacrylate), TMP3EOTA (Ethoxylated Trimethylolpropane Triacrylate), TMP3POTA (trimethylolpropane-3PO-triacrylate), TMP9EOTA (Ethoxylated(9) trimethylolpropane triacrylate), TMP15EOTA (Ethoxylated Trimethylolpropane Triacrylate), G3POTA (Propoxylated Glyceryl Triacrylate), TMPTMA (Trimethylolpropane trimethylacrylate), TMP3EOTMA (Ethoxylated Trimethylolpropane Trimethacrylate) and the formula thereof is shown below:

### Tri(meth)acrylate and Multi-functional(meth)acrylate (R₁═H, CH₃)

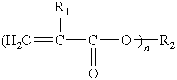

Wherein n≧3.

The multifunctional monomer can be DPHA (Dipentaerythritol Hexaacrylate), PET4A (Pentaerythritol tetraacrylate), PET5EO4A (Pentaerythritol Tetraacrylate Omnimer), DiTMP4A (Ditrimethylolpropane Tetraacrylate), PET5PO4A (Propoxylated Pentaerythritol Tetraacrylate), and so on.

There may be further additions added in the UV-curing resin, for example, one of or mixture of two of organic or inorganic composite, photo initiator, leveling agent, antifoam agent, defoamer, lubricant, and so on. The additions are about from 0.1% to 20% of the photo-curing compose resin. On the other hand, the thermal-curing resin can be Acrylic Polyol resin, Polyester Polyol resin, Polyimide, Urea resin, Phenol resin, or Epoxy resin.

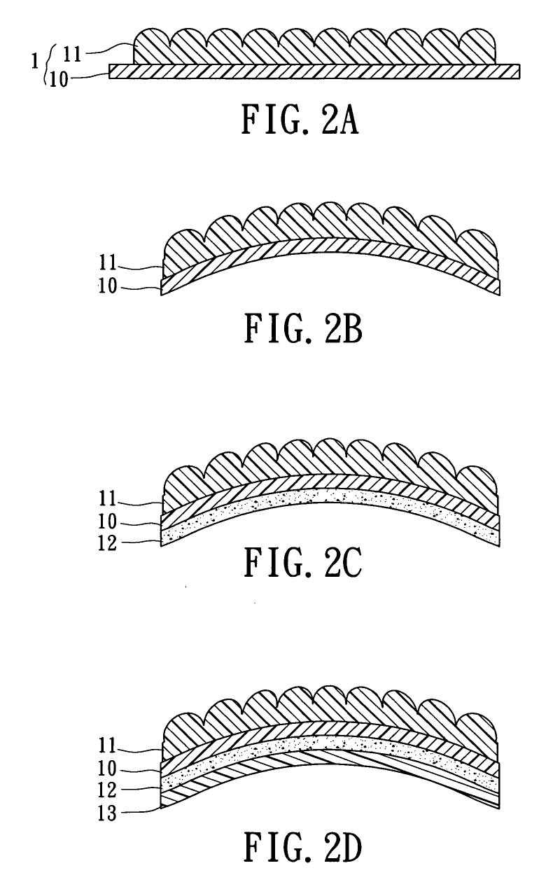

Step three is curing the photo-curing compose resin to form a plurality of patterns 11 on the upper surface of the plastic article 10, as shown in FIG. 2A. In this step, different curing method is applied for the different kind of the resin. For example, a UV light with energy of 50-3000 mj/cm² is projected on the UV-curing resin. Alternatively, a thermal curing method of baking the thermal-curing resin at 60-200° C. from one minute to one hundred minutes is applied for curing the thermal-curing resin. The patterns 11 has high elongation property. Moreover, in the curing process, a roller with structures thereon or a mold with structures is used for forming the patterns 11; thereby the patterns 11 have structures of rectangular solid structures, cone structures, polygon solid structures, another 2D/3D structures, or strips.

The article 1 is constructed by the plastic article 10 and the patterns 11. Because of the elongation property of the plastic article 10 and the patterns 11, the article 1 can be directly shaped in predetermined shape. In another words, when the article 1 is forced to be shaped, the two layers of the article 1 (i.e., the plastic article 10 and the patterns 11) can still attach to each other without cracking or peeling. Furthermore, the patterns 11 has high hardness and the patterns 11 can express various effects, such as metallic looking, leather effect, specific drawing or symbols. In another words, the patterns 11 can provide multi functions, such as being a protection layer and showing some visual effects.

However, before step two of the above-mentioned process, a step for adding organic or inorganic micro particulates in the photo-curing compose resin is provided. For example, the PU (Polyurethane) particulates with diameter of 1-100 μm and silica dioxide particulates with diameter of 1-100 nm are mixed into the photo-curing compose resin by stirring means so that the particulates are distributed uniformly in the photo-curing compose resin. The organic or inorganic micro particulates can be one of or two of PMMA, Silica dioxide, Cerium dioxide, Aluminum trioxide, Zinc oxide, and Sodium oxide. The organic or inorganic micro particulates are about from 0.1% to 60% of the photo-curing compose resin.

The photo-curing compose resin further has inorganic hybrids (i.e., inorganic composites) or organic hybrids (i.e., organic composites) or a mixture of inorganic hybrids and organic hybrids. The hybrids are about from 0.1% to 50% of the photo-curing compose resin. In other words, the photo-curing compose resin further includes one of or more than one of organic composite and inorganic composite in 0.1% to 50% weight ratio of the photo-curing compose resin.

Please refer to FIG. 2B; step four is forming the article 1 in a predetermined shape. In this step, the article 1 with high elongation property is formed into the shape of the final product (i.e., the casing of cellular phone) by a high pressure, a high temperature forming method, or a vacuum forming method. In the process of the present invention, although the patterns 11 has been cured and then shaped; but because of the elongation property of the patterns 11, the patterns 11 may be fixed on the plastic article 10 without broken or peeling issue from the high pressure, high temperature, or vacuum.

Please refer to FIG. 2C; step five is printing an ink layer 12 on bottom surface of the plastic article 10 of the article 1. The ink layer 12 is formed by printing color ink on the bottom surface of the plastic article 10 of the article 1 and the ink layer 12 can express colorful strips and lines or 3D effects.

Please refer to FIG. 2D; step six is injecting and attaching a plastic material 13 to the bottom surface of the plastic article 10 that has the ink layer 12. In this step, the shaped plastic article 10 with patterns 11, and the ink layer 12 are placed in a mold and then injecting and attaching a plastic material 13 on the ink layer 12 (i.e., the bottom surface of the plastic article 10 of the article 1) so that the plastic article 10, patterns 11, the ink layer 12, and the cured plastic material 13 are constructed as the casing the final product. The plastic material 13 can be made of PC (polycarbonate), PP (Polypropylene), PS (Polystyrene), PMMA (Polymethylmethacrylat), Methylmethacrylate styrene, ABS (acrylonitrile-butadiene-styrene), PET (Polyethylene Terephthalate), POM (Polyoxymethylene), Nylon, and so on. The shaped plastic article 10, patterns 11, and the ink layer 12 covered on top of the case 13 so as to form specific visual effects and patterns.

The present invention provides thirteen experiments for optimize the IMD process, wherein thirteen embodiments for photo-curing compose resin with various material ratio are provided and characteristic of these photo-curing compose resins are measured according to the experiments, so as to determine the optimized material ratio for the photo-curing compose resin. First, a photo-curing compose resin such as a UV-curing resin composite is provided. The UV-curing resin includes full acrylate resin with two or more than two functional groups (20-80 weight %), and preferably, the UV-curing resin is occupied with 40% to 60%. The UV-curing resin has acrylate resin with two or more than two functional group, organic or inorganic composite, and dilution (including one or more than one of monofunctional monomer, difunctional monomer, trifunctional monomer, and multifunctional monomer). In addition, the UV-curing resin further is mixed with the photo initiator, leveling agent, antifoam agent, defoamer, lubricant, and so on. Furthermore, wetted particulates are added into the above mixture about 5 to 60%. In the embodiments, two kinds of particulates of micro PMMA and nano silica dioxide are added into the UV-curing resin composite. The PMMA of 1-100 μm and silica dioxide particulates with diameter of 1-100 nm are mixed into the UV-curing resin composite by stirring means, for example stirring for 20 minutes, distributing and shaking by super sonic shaker for 1 hour. Then, the UV-curing resin composite is coated on a PC film of 200 μm (i.e. the plastic article 10) to form an un-cured UV-curing resin layer of 20 μm. Then, the patterns 11 are formed by pressing a roller with structure on the un-cured UV-curing resin layer and simultaneously curing the un-cured UV-curing resin layer by projecting UV light with energy of 1000 mj/cm² on the un-cured UV-curing resin layer in order to form the patterns 11. Next, the color ink is printed on the bottom surface of the PC film, which is the bottom surface of the plastic article 10 of the article 1, so as to form the ink layer 12. Next, the patterns 11, PC film (plastic article 10), and the ink layer 12 are together shaped into a primary structure with a predetermined shape. Then, the primary structure is placed into a mold and a material of acrylonitrile butadiene styrene (ABS), which is the plastic material 13, is injected on the primary structure and the plastic material 13 of ABS are constructed as the casing of the product.

Table 1 shows the parameters of the thirteen experiments.

TABLE 1

| | Wt % | | | | | | | |
|---|---|---|---|---|---|---|---|---|
| experiments | A | B | C | D | E | F | G | H |
| Sample 1 | 60% | 40% | | | | | | |
| Sample 2 | 60% | | 40% | | | | | |
| Sample 3 | 60% | | | 40% | | | | |
| Sample 4 | 60% | | | | 40% | | | |
| Sample 5 | 60% | | | | | 40% | | |
| Sample 6 | 50% | 20% | | 30% | | | | |
| Sample 7 | 50% | 30% | | 20% | | | | |
| Sample 8 | 50% | 40% | | 10% | | | | |
| Sample 9 | 50% | 10% | | | 10% | 30% | | |
| Sample 10 | 50% | 20% | | | 10% | 20% | | |
| Sample 11 | 50% | 30% | | | 10% | 10% | | |
| Sample 12 | 50% | 29.9% | | | 10% | 10% | 0.1% | |
| Sample 13 | 40% | 19.9% | | | 10% | 10% | 0.1% | 20% |

A: UV-curing resin
B: monofunctional monomer
C: difunctional monomer
D: trifunctional monomer
E: multifunctional monomer
F: organic/inorganic composite
G: additive
H: organic/inorganic filler

Analysis 1:

Table 2 shows the different property by adding different monomers in Sample 1 to 5. The testing method includes anti-wear property and elongation property. The steel tester with 100 gram repeatedly rubbing onto the samples about 100 times and the transmission analyzer are used for analyzing the “Haze” difference of the samples for testing the anti-wear property. On the other hand, a mold with height of 10 mm and R-value of 0.4 mm is used for testing the elongation (formability) of the article 1. Table 2 shows the results of the abrasion and the elongation tests. The results shows that the monofunctional monomer can be added into the resin composite in order to obtain the greatest formability, but the hardness and the abrasion does not improve (Sample 1). On the other hand, when the difunctional monomer (or more than two functional groups) is added into the resin (Samples 2-5) and the hardness and the abrasion are improved, but the elongation (formability) is worse than sample 1.

TABLE 2

| | Items | | | | |
|---|---|---|---|---|---|
| | | | | RCA | Formability |
| | Hardness | Adhesion | ΔHaze | (Cycles) | (Elongation) |
| Sample 1 | 2B | 5B | 13.86 | <10 cycles | better |
| Sample 2 | F | 5B | 7.32 | >300 cycles | normal |
| Sample 3 | H | 5B | 5.71 | >350 cycles | normal |
| Sample 4 | 2H | 5B | 2.39 | >500 cycles | normal |
| Sample 5 | H | 5B | 0.84 | >800 cycles | normal |

Analysis 2:

Table 3 shows the different property of the IMD product by different weight ratio of trifunctional monomers in Sample 6 to 8. The results show that when the weight ratio of the trifunctional monomer is more than 20% (Samples 6, 7), the hardness and the abrasion can be highly improved, but the property of the formability is decreased. Therefore, the weight ratio of the trifunctional monomer has to be less than 10% (Sample 8) in order to improve the formability of the article 1.

TABLE 3

| | Items | | | | |
|---|---|---|---|---|---|
| | | | | RCA | Formability |
| | Hardness | Adhesion | ΔHaze | (Cycles) | (Elongation) |
| Sample 6 | F | 5B | 9.13 | >300 cycles | normal |
| Sample 7 | HB | 5B | 10.79 | >200 cycles | normal |
| Sample 8 | B | 5B | 12.37 | <30 cycles | better |

Analysis 3:

Table 4 shows the different property of the IMD product by different weight ratio of organic/inorganic composite in Sample 9 to 11. The results show that when the weight ratio of the organic/inorganic composite is more than 20% (Samples 9, 10), the hardness and the abrasion can be improved, but the property of the formability is normal. Therefore, the weight ratio of the organic/inorganic composite has to be less than 10% (Sample 11) in order to improve the formability of the plastic multi-layer article 1.

TABLE 4

| | Items | | | | |
|---|---|---|---|---|---|
| | | | | RCA | Formability |
| | Hardness | Adhesion | ΔHaze | (Cycles) | (Elongation) |
| Sample 9 | F | 5B | 4.27 | >350 cycles | normal |
| Sample 10 | F | 5B | 5.83 | >300 cycles | good |
| Sample 11 | HB | 5B | 6.98 | >200 cycles | better |

Analysis 4:

Table 5 shows the different property of the IMD product by different agent and filler in Sample 11 to 13. The results show that when the lubricant is added into the resin (Samples 12 and 13), the hardness and the abrasion can be slightly improved, and the property of the formability does not decrease. Furthermore, the organic/inorganic filler can improve hardness and the abrasion highly, and the formability of the article 1 is also maintained (Sample 13).

TABLE 5

| | Items | | | | |
|---|---|---|---|---|---|
| | | | | RCA | Formability |
| | Hardness | Adhesion | ΔHaze | (Cycles) | (Elongation) |
| Sample 11 | HB | 5B | 6.98 | >200 cycles | better |
| Sample 12 | F | 5B | 9.89 | >250 cycles | better |
| Sample 13 | 2H | 5B | 0.02 | >1000 cycles | better |

Accordingly, the composite of samples 12 and 13 are the better embodiments of the present invention. The preferable process includes the steps of:

Step 1: The UV-curing resin composite is provided. The UV-curing resin with elongation property is about 50% in weight of the composite (the preferable range is from 40% to 60%). The dilution includes difunctional and trifunctional monomers of 30%-40% in weight of the composite. The organic/inorganic composite is about 10%-20% in weight of the composite. The additives include photo initiator, leveling agent, antifoam agent, defoamer, lubricant of 5% in weight of the composite. These components are mixed uniformly.

Step 2: adding the particulates into the resin. Wetted particulates of 5-50% in weight are added into the UV-curing resin composite. The PMMA particulates of 1-100 μm and silica dioxide particulates with diameter of 1-100 nm are mixed into the polymer resin by stirring means, for example stirring for 20 minutes, distributing and shaking by super sonic shaker for 1 hour

Step 3: coating the resin. The UV-curing resin composite is coated on a PC film of 200 μm (i.e. the plastic article 10) to form an un-cured UV-curing resin layer of 20 μm.

Step 4: forming the patterns 11. The patterns 11 are formed by pressing a roller with structure on the un-cured UV-curing resin layer and simultaneously curing the un-cured UV-curing resin layer by projecting UV light with energy of 1000 mj/cm² on the un-cured UV-curing resin layer, shown in FIG. 2A. Therein the plastic article 10 and the patterns 11 form an article 1.

Step 5: stripping the plastic article 10 with the patterns 11 from the mold.

Step 6: shaping the plastic article 10 with the patterns 11 by pressure forming method or vacuum forming method, shown in FIG. 2B.

Step 7: printing the ink layer 12. The color ink is printed on the bottom surface of the plastic article 10 of the shaped article 1 so as to form the ink layer 12, shown in FIG. 2C.

Step 8: forming the plastic material 13. The primary structure is placed into a mold and a material of ABS (i.e. the plastic material 13) is injected on the primary structure and the case of ABS are constructed as the casing of the product, shown in FIG. 2D.

Therefore, the present invention provides some advantages as following.

1. The patterns 11 having high elongation characteristic are formed on the plastic article 10. Thus, the pattern 11 can be shaped after it is cured. In another words, it is not necessary to cure a second time for the shaped patterns 11. Therefore, the traditional IMD process is simplified and the equipment of curing the patterns 11 is also solved. Moreover, the patterns perform as a protection layer for the inner layers.

2. When the article 1 is being shaped, the patterns 11 can be attached firmly on the plastic article 10, due to the formability of the patterns 11. Thus, there is no peeling or broken issue between the two-layer article.

3. Regarding with the traditional Dual Cure method, only on curing step is provided in the present invention. Therefore, it is not necessary for the client to cure the resin and the cost is reduced. Moreover, the un-cured resin has no anti-wear property and the inner structures are damaged easily in processing or transportation. In other words, the manufacturing yield is low for the traditional dual cure method. On the contrary, with the present invention the cured resin can be used for protecting the inner structures and the manufacturing therefore the yield is highly improved. Furthermore, the IMD product of the present invention meets the regulation of RoHS so that the present invention provides an environment-friendly product.

Even though the present invention has been described with reference to the foregoing preferred embodiment, it shall be understood that the present invention is not limited to the details thereof. Various equivalent variations and modifications may occur to those skilled in this art in view of the teachings of the present invention. Thus, all such variations and equivalent modifications are also embraced within the scope of the present invention as defined in the appended claims.

What is claimed is:

1. A manufacturing method for an article of photo-curing compose resin, comprising:
providing a plastic article with an upper surface and a bottom surface, a photo-curing compose resin, an ink layer, and a plastic material;
coating the photo-curing compose resin on the upper surface of the plastic article;
pressing and curing the photo-curing compose resin to form a plurality of patterns;
shaping the plastic article with the patterns;
coating the ink layer on the bottom surface of the plastic article; and
injecting the plastic material to attach the plastic material with the ink layer.

2. The manufacturing method according to claim 1, wherein the plastic article is made of Polyethylene Terephthalate (PET), Polycarbonate (PC), Tri-acetyl Cellulose (TAC), Polymethylmethacrylate (PMMA), Methylmethacrylate (styrene), or Cyclic Olefin Copolymer (COC), and the thickness of the plastic article is from 10 μm to 1000 μm.

3. The manufacturing method according to claim 1, wherein the photo-curing compose resin has one of or more than one of full acrylate resin, polyester acrylate, epoxy acrylate and polyurethane acrylate from 5% to 95% of the photo-curing compose resin.

4. The manufacturing method according to claim 1, further comprising a dilution, the dilution has one monomer, the monomer includes one or more than one of monofunctional monomer, difunctional monomer, trifunctional monomer, and multifunctional monomer in 5% to 95% weight ratio of the photo-curing compose resin.

5. The manufacturing method according to claim 1, wherein the photo-curing compose resin further comprises one of or more than one of photo initiator, leveling agent, antifoam agent, and lubricant in 0.1% to 20% weight ratio of the photo-curing compose resin.

6. The manufacturing method according to claim 1, wherein the photo-curing compose resin further comprises one of or more than one of organic composite and inorganic composite in 0.1% to 50% weight ratio of the photo-curing compose resin.

7. The manufacturing method according to claim 1, wherein the photo-curing compose resin further comprises organic or inorganic micro particulates with diameter of 1 nm-100 μm, the organic or inorganic micro particulates are one kind of or more than one kinds of PMMA, Silica dioxide, Cerium dioxide, Aluminum trioxide, Zinc oxide, and Sodium oxide in 0.1% to 60% weight ratio of the photo-curing compose resin, and the particulates are distributed in the photo-curing compose resin.
